(19) United States
(12) Patent Application Publication
(10) Pub. No.: US 2013/0191003 A1
(43) Pub. Date: Jul. 25, 2013

(54) AUTONOMOUS STARTUP

(71) Applicant: GM Global Technology Operations LLC, Detroit, MI (US)

(72) Inventors: Uwe HAHNE, Buettelborn (DE); Marco MOEBUS, Mainz (DE); Gerald SCHMIDT, Frankfurt am Main (DE); Thomas PFEIFFER, Goellheim (DE)

(73) Assignee: GM GLOBAL TECHNOLOGY OPERATIONS LLC, Detroit, MI (US)

(21) Appl. No.: 13/715,847

(22) Filed: Dec. 14, 2012

(30) Foreign Application Priority Data
Dec. 16, 2011 (DE) 102011121442.2

(51) Int. Cl. G05B 11/32

(52) U.S. Cl. CPC G05B 11/32
USPC 701/99

(57) ABSTRACT

A method and a device for the autonomous startup of a motor vehicle from a standing position, which is determined by a traveling sensor, is provided. The type of road for the current motor vehicle position is determined via a navigation device or environmental sensors. In specific types of roads, a preceding deceleration to a complete stop is followed by the automatic activation of an auto-go mode, in which a control unit initiates an autonomous startup of the vehicle by way of a startup unit once a startup acquisition unit has determined that the other motor vehicle has started up.

### CROSS-REFERENCE TO RELATED APPLICATIONS

This application claims priority to German Patent Application No. 10 2011 121 442.2, filed Dec. 16, 2011, which is incorporated herein by reference in its entirety.

### TECHNICAL FIELD

This application pertains to a method for the autonomous startup of a motor vehicle from a standing position, a device for the autonomous startup of a motor vehicle from a standing position or for implementing the method, as well as a motor vehicle in which such a method is implemented or in which such a device is installed.

### BACKGROUND

Driver assistance systems permit the autonomous performance of tasks that previously were handled exclusively by the driver of a motor vehicle. In particular, so-called “adaptive cruise control” systems (ACC systems) are known, which determine the speed and distance of a vehicle driving in front of the driver's vehicle, and adjust the speed of the driver's vehicle accordingly, so as to ensure a safe distance. If necessary, ACC systems are also able to decelerate the driver's vehicle until it comes to a complete stop if the vehicle in front has also stopped. For example, such a system is described in DE 199 58 520 A1. Described therein is a speed governor also intended to permit an autonomous startup from a standing position. However, the driver is preferably to approve startup by activating a corresponding key, so that there ultimately is no autonomous startup at all.

Therefore, it may be desirable to provide a method and driver assistance system that enable autonomous startup while maintaining traffic safety. In addition, other objects, desirable features and characteristics will become apparent from the subsequent summary and detailed description, and the appended claims, taken in conjunction with the accompanying drawings and this background.

### SUMMARY

The various teachings of the present disclosure provides a method for the autonomous startup of a motor vehicle from a standing position when the startup of another motor vehicle located in front of the motor vehicle has been determined. Within the framework of the method according to the present disclosure, environmental sensors or a navigation device are used to acquire the type of road corresponding to the current motor vehicle position, wherein an auto-go mode is automatically activated after a preceding deceleration to a complete stop for specific types of roads, in which the vehicle is autonomously started up as soon as a startup of the other motor vehicle has been determined The braking process can be handled by a driver assistance system or actively by the driver by pressing the brakes, or if necessary by allowing the vehicle to roll to a complete stop.

The term “specific type of road” is understood as a categorization based on the probability of encountering pedestrians and/or cyclists on or next to the roadway, such as freeways, highways, or tunnels, where pedestrians are not expected to be, as opposed to city streets, where pedestrians and/or cyclists are routinely encountered. The underlying idea here is that specific types of roads are those where there is no realistic danger of pedestrians or cyclists being present at the site of ongoing traffic activity who might be endangered by an autonomous startup. If several motor vehicles are in front of the motor vehicle, the additional motor vehicle must realistically be viewed as the one immediately in front of the driver's motor vehicle.

The term auto-go mode is self-explanatory, and denotes a mode that enables an autonomous startup of the motor vehicle from a standing position.

Suitable environmental sensors are generally known, and also used in other areas of automotive engineering, for example in parking assist systems or active cruise control systems. Examples of environmental sensors include ultrasonic sensors or electromagnetic sensors like radar, infrared or LIDAR systems, which determine the distance and speed of the vehicle in front of the driver's vehicle through the reflection of radiated sound waves or electromagnetic waves, or optical sensors as special electromagnetic sensors. In a broader sense, environmental sensors are regarded as communication systems that enable communication directly between the vehicles involved or indirectly through a central office, with which the startup of the vehicle in front of the driver's vehicle can be determined

Additional exemplary embodiments of a method according to the present disclosure provide that the auto-go mode be activated again if a short distance is covered after an autonomous startup according to the present disclosure and/or only a low top speed is reached in the interim before again decelerating. These short distances generally range from about 0.5 to about 25 meters, in one example, about 1 to about 10 meters, or in another example about 2 to about 5 meters, and attained top speeds measure at most up to about 30 km/h, generally up to about 20 km/h. This advantageously enables a repeated automatic startup even in situations of bumper-to-bumper traffic, so-called stop-and-go traffic. In the absence of preconditions for autonomous startup, in one example, the suitable type of road, the auto-go mode is of course also not activated again.

One exemplary embodiment of the method provides that an introduced autonomous startup be displayed to the driver by an optical, acoustic and/or haptic signal, so as to emphatically tell the latter that startup has taken place.

According to another exemplary embodiment, the auto-go mode is automatically activated when the type of road is a freeway, a highway, a multi-lane city road or a tunnel. In these types of roads, it can advantageously be assumed that no pedestrian or cyclist is on the roadway. In one example, in the case of multi-lane city roads, special crossings are set up for these traffic participants to go across the roadways.

Another exemplary embodiment provides a safety mechanism in which the auto-go mode is not activated if the type of road has a speed limit of about 50 km/h or less. This advantageously prevents an autonomous startup from taking place in normal city traffic, where it most certainly can be expected that pedestrians or cyclists will be unexpectedly encountered in the vicinity of the motor vehicle.

Methods known to one of skill in the art are possible for determining the type of road. In one exemplary embodiment, the environmental sensors are used for the optical acquisition of traffic, road and/or direction signs, along with corresponding image data processing. For example, corresponding traffic, road and/or direction signs denote freeway entrances and exits, arrival at a city or departure from a city, the presence of multiple lanes, in particular at locations where directions to merge into a single lane are given, tunnel entrances, or speed limits that apply to the respective street. For example, the vehicle environment can be captured by one or more cameras, wherein known image processing systems are used to analyze image information from the photograph taken of the vehicle environment and check it for traffic, road and/or direction signs. For example, a corresponding system is mentioned in WO 2011/141016 A1. For example, if a traffic sign denoting entry by the motor vehicle onto a freeway is identified in the traveling direction, this ensures a suitable type of road. For example, logos of petroleum companies at gas stations can serve as direction signs suggesting that the motor vehicle is located at a gas station area where people are to be expected, so that autonomous startup is not advised.

Another exemplary embodiment provides for using the environmental sensors to acquire traffic data transmitted by radio. Corresponding systems are known, for example described in WO 2011/115587, and easy to integrate into the present disclosure. For example, information about the type of road just traveled can be transferred to the motor vehicle, and/or other information, e.g., about the speed limit for the road just traveled, from which inferences can be drawn about the type of road just traveled.

According to another exemplary embodiment of the method, the speed of the motor vehicle before the last deceleration process in which the motor vehicle came to a complete stop is determined, and the auto-go mode is activated as a function thereof. Activation takes place in particular when a specific speed limit has not been dipped below. One example for such a speed limit is a speed limit exceeding about 50 km/h. Certain exemplary embodiments provide that the speed be acquired over a specific period of time before the deceleration process, wherein the speed limit cannot be dipped below within this period of time, for example about ten seconds to several minutes.

Additional exemplary embodiments of the method according to the present disclosure provide that a driver alertness recognition system acquires information about the alertness of the driver, and an initiated startup process is terminated if an absence of alertness is determined after a specific time, in one example, after about 1 to about 5 seconds, or after a specific distance has been covered, in one example, about 1 to about 5 meters. If necessary, termination of the startup process is initially preceded by an acoustic, optical and/or haptic warning to the driver. The latter gives the driver a chance by way of a driver operating command to prevent the termination from happening at all, or canceling an already introduced termination, and thereby let the startup process continue after all. Systems for recognizing driver alertness are known, and based among other things on an analysis of viewing direction and/or pupil movement, frequency of movement, placement of at least one hand, and if possible both hands, on the steering wheel, and the like. This always allows the fastest possible startup of the vehicle from a standing position if the driver currently is not himself or herself actually using the latter for a startup at the time of the potential startup. The described exemplary embodiment advantageously ensures that autonomous startup does not create any hazardous situation, since the alertness of the driver is verified after a specific time, and the startup process is terminated, with the motor vehicle in particular being decelerated until reaching a complete stop if no signs of manifested alertness are detected. According to a another exemplary embodiment, an auto-go mode cannot be activated if no driver alertness is determined in advance, or if no driver alertness is currently detected with the auto-go mode already activated.

Other configurations of the method according to the present disclosure provide that the activated auto-go mode remains activated for the duration of an auto-go time window, after which it is deactivated. According to another exemplary embodiment of the method, the auto-go time window can be adjusted. While it makes sense for the factory to prescribe a standard value, for example ranging from about 2 seconds to about 40 seconds, the driver can change it at any time. For example, it may make sense to extend the time to several minutes during a traffic jam on the freeway, or while waiting in front of a railroad gate. Also provided is the option to have the duration of the time window set automatically as a function of what traffic situation has just been determined A long time window makes sense given a traffic jam on the freeway, while shorter time windows are appropriate in a stop-and-go situation.

Another exemplary embodiment of the method provides that the auto-go time window, and hence also the auto-go mode, ends within about 2 minutes of its activation, generally within about 20 seconds. The shorter the time window, the higher the probability that an autonomous startup will take place at a point where there has been no fundamental change in the traffic situation. Longer time windows make sense in particular when it can be assumed that the traffic situation will remain constant.

Also provided are options in which a driver operating command can be given with the auto-go time window activated so as to restart the latter, i.e., make its maximum duration available once again, or reactivate the auto-go time window with a driver operating command upon expiration of an auto-go time window in which no autonomous startup took place. There are potential technical solutions known to the expert for such a driver operating command, for example activating controls, such as switches or keys, which can be accommodated on the steering wheel, gear shifts, or other control consoles, making entries on keyboards or touch screens, or having the driver issue voice commands that are interpreted by a voice recognition system. Another exemplary embodiment of the method provides that the driver can issue a corresponding driver operating command with the vehicle at, or even coming to, a complete stop. The latter is advantageous in particular when the driver can anticipate that his or her vehicle will be coming to a complete stop, and will continue on after standing idle for a certain time. For example, even before stopping in front of a red light or closed railroad gate, a vehicle can be authorized to autonomously continue driving again once the light has changed, the vehicle in front of the driver's vehicle has moved off, or the railroad gate has lifted.

Another exemplary embodiment provides that the auto-go time window is only autonomously activated after the motor vehicle has been completely stopped for a specific period of time, and thus after a waiting period, for example at the earliest after about one to about five seconds, e.g., about two to about five seconds or about three to about four seconds, wherein this late activation can be preset or ordered by way of a driver operating command. Such a mode is advantageous in particular in cases where the driver can anticipate that an upcoming driving situation will call for the vehicle to repeatedly stop for brief intervals, during which no autonomous startup is desired. One example of such a driving situation is parking, which requires maneuvering, and hence repeated vehicle stops to switch gears between forward and reverse. The auto-go time window can be activated at any time according to the statements made above by issuing a separate driver operating command, thereby interrupting the waiting period.

The activation and/or remaining duration of activation of the auto-go mode is generally displayed to the driver visually, acoustically and/or haptically. Also conceivable is to light up an indicator field to display the activation, if necessary in different colors, count down the time still remaining on a numerical display, or activate signal tones or blinking signals, which repeat at an ever faster rate as the activation period nears its end. For example, a haptic display can involve a vibration of the steering wheel, gear shift or parts thereof

Another exemplary embodiment of the method according to the present disclosure provides that the auto-go mode can be activated or is deactivated via a driver operating command from the driver.

Technical solutions known to the expert are possible for driver operating commands given within the framework of a method according to the present disclosure, such as activating controls like switches or keys, which can be accommodated on the dashboard, steering wheel, gear shift or other control consoles, or voice commands of the driver, as already described above.

Another exemplary embodiment of a method according to the present disclosure provides that the environmental sensors be used to determine whether the other vehicle has activated a turn signal, wherein the auto-go mode is only activated if navigation route data have determined that the traveling direction of the other vehicle corresponds to the desired driving route of the motor vehicle. This is especially advantageous in turning situations, since a startup by the other motor vehicle does not necessarily mean that it will chose the same traveling direction as the driver's vehicle. For example, if the other motor vehicle indicates that it intends to turn with a turn signal, and if the driver's motor vehicle is to continue traveling straight, this in no way guarantees that the way is clear for straight ahead travel. In such a case, evaluating the turn signal of the other vehicle ensures that no faulty startup will take place. Alternatively, the motor vehicle can independently obtain traffic information that ensures that the way is clear for the desired traveling direction. If the desired route of the motor vehicle includes a curve, another exemplary embodiment of the method can also incorporate the autonomous initiation of cornering in addition to the autonomous startup of the driver's vehicle.

Another exemplary embodiment of the method according to the present disclosure provides that the auto-go mode is only activated if environmental sensors have determined that no pedestrians or cyclists are in the vicinity. This advantageously precludes any residual risk of personal endangerment. For example, in a traffic jam on a freeway caused by an accident, it sometimes happens that passengers in the crashed vehicles are located on or near the lanes not obstructed by the accident damaged vehicles. When approaching a rest area on a freeway, which the navigation system might still view as being the freeway due to an insufficiently resolved position, people must naturally be expected to be in the vicinity. Despite a case where cars are lined up at the gas station, this precludes an inexpedient autonomous startup.

The present disclosure further relates to a device for implementing a method according to the present disclosure. The device encompasses a road type acquisition unit for determining the type of road, a startup acquisition unit for determining the startup of a vehicle in front of the motor vehicle, a startup unit for the autonomous startup of the motor vehicle, possibly enhanced by an automatic steering unit, as well as at least one environmental sensor and/or a navigation device or navigation system.

Various exemplary embodiments can be used for the road type acquisition unit. In one exemplary embodiment, it represents a navigation device or navigation system, whose information about the current position of the motor vehicle can simultaneously also be allocated to map data about the street being traveled on. Alternatively or additionally, the road type acquisition unit encompasses at least one environmental sensor, as described above within the framework of the method according to the present disclosure. For example, ultrasonic, radar, LIDAR or optical sensors can in this way be used to determine the distance between two reflector posts on a street, from which an inference can be made as to the type of road, or the number of lanes in the driver's traveling direction and/or the opposite direction, or the speed of the vehicles driving thereon, from which a conclusion can also be drawn about the type of road.

The startup acquisition unit for determining the startup of a vehicle in front of the motor vehicle can also make use of the already mentioned environmental sensors, which as a rule are already present in motor vehicles anyway for other functions, such as parking assist or adaptive cruise control systems. Alternatively or additionally provided is a communications unit, which can be used to derive information about the startup of another vehicle directly from it, for example within the framework of so-called car-to-car communication (Car2Car or C2C communication).

The startup unit enables an automatic startup of the motor vehicle. Given an automatic transmission, a command for positioning the gas pedal is substantially given, which initiates an autonomous startup. In the case of a manual transmission, the startup unit also shifts into first gear. If necessary, automatic steering also takes place if the traveling route of the motor vehicle provides for a turning angle of the steering wheel following the startup.

Various known solutions can be used in the environmental sensors for determining the current motor vehicle position, for example the sensors mentioned above within the framework of the road type acquisition unit, which in fact can perform multiple functions in both the device according to the present disclosure and the method according to the present disclosure. In certain exemplary embodiments, the environmental sensors are optical sensors, with which the position of the motor vehicle can be determined via the recognition of traffic or road signs. Another exemplary embodiment involves electromagnetic sensors, in particular receivers and/or transmitters of radio waves, which make it possible to obtain information about the location. Another exemplary embodiment provides a navigation device or navigation system, wherein the position of the motor vehicle is ascertained via the signals of a global positioning system, for example a positioning system supported by satellites or terrestrial radio beacons.

A travel sensor determines when the motor vehicle has come to a complete stop, and is usually present in the vehicle anyway, for example to acquire data from the tachometer or ascertain the wheel speed. Alternatively or additionally, a complete stop can also be determined by environmental sensors, for example by an unchanging vehicle environment.

A control unit acquires the data collected from the startup acquisition unit, road type acquisition unit, environmental sensors and/or navigation device. If the motor vehicle is completely stopped and the data collected from the road type acquisition unit yield a suitable type of road, the control unit automatically activates the auto-go mode. As soon as the acquisition unit has detected the startup of the other motor vehicle in front of the motor vehicle, the control unit initiates an automatic startup of the motor vehicle by way of the startup unit.

In addition, another exemplary embodiment provides for at least one additional technical means selected from a driver alertness recognition system, an auto-go mode display and an auto-go mode actuator. Both at least one driver alertness recognition system along with an auto-go mode display and auto-go mode actuator are generally present.

Corresponding driver alertness recognition systems have already been addressed within the framework of the method according to the present disclosure, and are based, for example, on an analysis of viewing direction and/or pupil movement, the frequency of movement, the placement of at least one hand, and if possible both hands, on the steering wheel, and the like.

The auto-go mode display can involve known means, which visually, acoustically and/or haptically display the activation and/or remaining duration of activation of the auto-go mode to the driver. Examples of suitable means were already addressed within the frame work of the method according to the present disclosure.

The auto-go mode actuator can be realized with known means, for example those cited as an example within the framework of the method according to the present disclosure for issuing driver operating commands

The present disclosure further relates to a motor vehicle that encompasses a device according to the present disclosure or in which a method according to the present disclosure is implemented.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a schematic view of a device according to the present disclosure; and

FIG. 2 is a schematic view of an expanded device according to the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

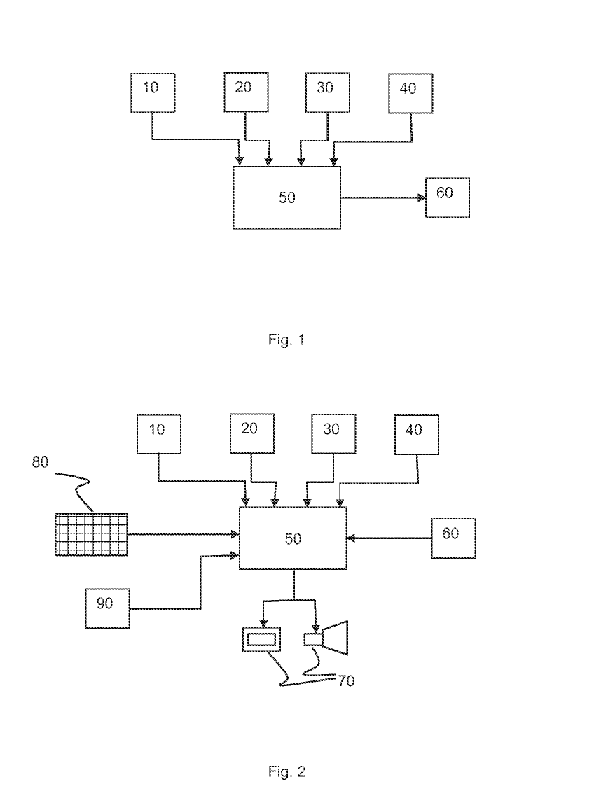

FIG. 1 shows a schematic view of a device according to the present disclosure for use in a motor vehicle. A navigation device 10, an environmental sensor 20, and a traveling sensor 40 transmit data to a control unit 50. If the data from the navigation device 10 and/or environmental sensor 20 confirm a type of road suitable for implementing a method according to the present disclosure, and the motor vehicle is at a complete stop based on data from the vehicle sensor 40, the control unit 50 can activate the auto-go mode. If the startup acquisition unit 30 detects the startup of another vehicle in front of the motor vehicle, the control unit 50 issues a command to the acquisition unit 60. The motor vehicle is correspondingly autonomously started up according to the present disclosure.

FIG. 2 shows an expanded exemplary embodiment of the device according to the present disclosure, which additionally depicts an auto-go mode display 70, an auto-go mode actuator 80 as well as a driver alertness recognition system 90. For example, the auto-go mode display 70 can involve a tone output, as symbolized by a loudspeaker, as well as an optical output, symbolized by an indicator field. Accordingly, an activated auto-go mode and possibly its duration can be indicated via audio signals and/or blinking signals. The auto-go mode actuator 80 is symbolized by a keyboard, and makes it possible to activate or deactivate the auto-go mode, set an auto-go time window selected by the driver, or reset the maximum duration of an already expired auto-go time window.

A first example for the method according to the present disclosure is described below. A motor vehicle is driving on the freeway. Based on data from the navigation device 10, it is determined within the framework of the method according to the present disclosure that the motor vehicle is on a freeway. A traffic jam has developed at some location on the freeway, at which the motor vehicle will be forced to decelerate until completely stopped. Numerous other motor vehicles are in front of the motor vehicle, and also sitting in traffic. Since a freeway was determined as the type of road currently being travelled, the auto-go mode according to the present disclosure is activated after the motor vehicle has decelerated, and acoustically and optically signaled to the driver via the auto-go mode display 70. When the other motor vehicle directly in front of the motor vehicle starts up, the driver's motor vehicle is autonomously started up. In view of the ascertained type of road, the roadway is not expected to have any pedestrians or cyclists, just additional motor vehicles, thereby safeguarding traffic safety despite the startup.

A second example for the method according to the present disclosure is described below.

A motor vehicle is located in a city. The environmental sensors 20 determine that the motor vehicle is on a multi-lane roadway. The roadway leads to a set of traffic lights, which forces the motor vehicle and other motor vehicles in front of it to slow down and stop. In view of the determined vehicle position, the deceleration to a complete stop activates the auto-go mode. The auto-go mode remains active for about 20 seconds in this exemplary embodiment. During next green phase of the traffic light, which still lies within this auto-go time window, the other motor vehicle directly in front of the motor vehicle starts up, triggering an autonomous startup of the motor vehicle.

In a third example, the automatic startup is once again followed by a deceleration to a complete stop within the framework of the traffic jam or traffic light situation mentioned in the preceding examples, because the traffic jam does not clear up right away, or the green phase of the traffic light is not long enough to allow all motor vehicles to pass through the light. The result is bumper-to-bumper traffic, in which the motor vehicle can only move forward in short increments at a time, or only reaches low top speeds. After a renewed deceleration to a complete stop in response to other motor vehicles also slowing down, the auto-go mode is activated again, since a traffic situation involving bumper-to-bumper traffic can be inferred from the movement profile.

In a fourth example, after the autonomous startup that took place in examples 1 and 2, an alertness recognition system 90 determines that the driver is not alert within a preset time of several seconds. The vehicle is thereupon automatically decelerated to a complete stop again.

In a fifth example, a motor vehicle on a multi-lane city roadway is in a long line of waiting vehicles at a traffic light. The driver recognizes that the preset duration of the auto-go time window will not be long enough to reach the next green phase in which an autonomous startup could take place. He or she uses an auto-go mode actuator 80 to set a longer value for the auto-go time window, which ensures that the auto-go time window will extend to the respectively next green phase.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for an autonomous startup of a motor vehicle from a standing position when the startup of another motor vehicle located in front of the motor vehicle has been determined, comprising:
acquiring a type of road corresponding to the current motor vehicle position via a navigation device or environmental sensors; and
automatically activating an auto-go mode after a preceding deceleration to a complete stop for specific types of roads, in which the vehicle is autonomously started up as soon as a startup of the other motor vehicle has been determined

2. The method according to claim 1, wherein the auto-go mode is activated again if only at least one of a short distance is covered and a low top speed was reached after an autonomous startup and up until a renewed deceleration to a complete stop.

3. The method according to claim 1, further comprising:
automatically activating the auto-go mode if the type of road is a freeway, a highway, a multi-lane city roadway or a tunnel

4. The method according to claim 1, further comprising:
not activating the auto-go mode if the type of road has a speed limit of about 50 km/h or less.

5. The method according to claim 1, wherein the environmental sensors optically acquire traffic, road signs, direction signs.

6. The method according to claim 1, wherein the environmental sensors acquire traffic data transmitted by radio.

7. The method according to claim 1, further comprising:
determining the speed before the last deceleration process, and the auto-go mode is activated as a function thereof

8. The method according to claim 1, wherein a driver alertness recognition system acquires information about the alertness of the driver, and the method further comprises:
terminating an initiated startup process if an absence of alertness is determined after a specific time or covered distance; and
signaling the impending termination to the driver via at least one of an acoustic, optical and haptic warning, if necessary, making it possible to avoid the latter by way of a driver operating command.

9. The method according to claim 1, wherein the activated auto-go mode remains activated for the duration of an auto-go time window, and is deactivated thereafter.

10. The method according to claim 9, further comprising:
displaying at least one of the activation and remaining duration of activation of the auto-go mode to the driver at least one of visually, acoustically and haptically.

11. The method according to claim 10, wherein the auto-go mode can be activated or is deactivated via a driver operating command.

12. The method according to claim 1, wherein the environmental sensors are used to determine whether the other vehicle has activated a turn signal, wherein the auto-go mode is only activated if navigation route data have determined that the traveling direction of the other vehicle corresponds to the desired driving route of the motor vehicle.

13. The method according to claim 1, wherein the auto-go mode is only activated if environmental sensors have determined that no pedestrians or cyclists are in the vicinity.

14. A device for an autonomous startup of a first motor vehicle from a standing position, comprising:
a road type acquisition unit for determining the type of road;
a traveling sensor that determines that the first motor vehicle has come to a complete stop;
a startup acquisition unit for determining a startup of a second motor vehicle in front of the first motor vehicle;
at least one of an environmental sensor and a navigation device; and
a control unit.

15. The device according to claim 14, further comprising at least one of:
an auto-go mode display;
an auto-go mode actuator; and
a driver alertness recognition system.

16. A motor vehicle, comprising:
a road type acquisition unit for determining the type of road;
a traveling sensor that determines that the motor vehicle has come to a complete stop;
a startup acquisition unit for determining a startup of a second motor vehicle in front of the motor vehicle;
at least one of an environmental sensor and a navigation device; and
a control unit that:
automatically activates an auto-go mode after a preceding deceleration to a complete stop for specific types of roads, in which the motor vehicle is autonomously started up as soon as a startup of a second motor vehicle in front of the motor vehicle has been determined
